(19) United States
(12) Patent Application Publication
(10) Pub. No.: US 2023/0046719 A1
(43) Pub. Date: Feb. 16, 2023

(54) SERVER DEVICE AND CONGESTION INFORMATION NOTIFICATION SYSTEM

(71) Applicant: TOSHIBA TEC KABUSHIKI KAISHA, Tokyo (JP)

(72) Inventors: Hidenori SOMEYA, Ichikawa Chiba (JP); Makoto NISHIDA, Yokohama Kanagawa (JP); Kazuki NAKAMURA, Ota Tokyo (JP)

(21) Appl. No.: 17/870,508

(22) Filed: Jul. 21, 2022

(30) Foreign Application Priority Data
Aug. 10, 2021 (JP) 2021-130677

(51) Int. Cl. G06Q 30/06

(52) U.S. Cl. CPC G06Q 30/0641; G06Q 30/0623

(57) ABSTRACT

According to one embodiment, a server device for a congestion notification system includes a communication interface to receive a request for congestion information from a user terminal, a storage unit for storing congestion information, and a processor. The processor is configured to extract the congestion information from the storage unit after the request is received and output the extracted congestion information to the user terminal via the communication interface. The congestion information output to the user terminal includes seat congestion information indicating a congestion state of seats shared by a plurality of stores, such as those arranged as food court or the like.

### CROSS-REFERENCE TO RELATED APPLICATION

This application is based upon and claims the benefit of priority from Japanese Patent Application No. 2021-130677, filed on Aug. 10, 2021, the entire contents of which are incorporated herein by reference.

### FIELD

Embodiments described herein relate generally to a server device, a congestion information notification system, and a program for such a device or system.

### BACKGROUND

Nowadays, a food court including a plurality of stores (generally restaurants) may be provided in a shopping center, mall, or the like. The food court has seats that may be shared by customers of any one of the plurality of stores. Use of seats provided in the food court is not generally restricted even to store customers. That is, even those people not eating and drinking can use the food court seats.

Accordingly, a user contemplating the use of the food court needs to learn not only the congestion state of a particular store at which the user is about to purchase food (or otherwise shop) but also the congestion state of seats available to users of the store in order to judge whether the user will be able to find seats to immediately eat and drink after purchasing items at the store. There is known a system that provides a congestion state of a particular restaurant (for example, JP-A-2014-71550 (Patent Literature 1)) that a potential customer is considering visiting.

However, since such an existing system only provides the congestion state of the particular restaurant, if such a system is applied to a food court-based restaurant or the like, the provided congestion information might not be entirely relevant to the user. This is because, in the food court or the like, it is also important for the user to know whether the shared seats in the food court are congested since such may be the case even if one particular store at the food court is not presently busy/congested with patrons. Accordingly, the related art is inadequate with respect to such food court scenarios and the like and has room for improvement in the convenience of users.

### BRIEF DESCRIPTION OF THE DRAWINGS

FIG. 1 is a diagram illustrating an overview of a congestion information notification system in an embodiment.

FIG. 2 is a diagram illustrating a food court to which a congestion information notification system can be applied.

FIG. 3 is a block diagram illustrating hardware aspects of a portable terminal in an embodiment.

FIG. 4 is a block diagram illustrating functional aspects of a portable terminal in an embodiment.

FIG. 5 is a block diagram illustrating hardware aspects of a server device in an embodiment.

FIG. 6 is a diagram illustrating a data configuration of a member master stored in a memory unit of a server device.

FIG. 7 is a diagram illustrating a data configuration of a store master stored in a memory unit of a server device.

FIG. 8 is a diagram illustrating a data configuration of a menu master stored in a memory unit of a server device.

FIG. 9 is a diagram illustrating a data configuration of a seat congestion information management file stored in a memory unit of a server device.

FIG. 10 is a diagram illustrating a data configuration of a store congestion information management file stored in a memory unit of a server device.

FIG. 11 is a diagram illustrating a data configuration of an order information management file stored in a memory unit of a server device.

FIG. 12 is a block diagram illustrating functional aspects of a server device.

FIG. 13 is a sequence chart illustrating an operation flow of a congestion information notification of a congestion information notification system.

FIGS. 14A, 14B, and 14C are each diagrams illustrating a display screen of a portable terminal at a congestion information notification time in an embodiment.

FIG. 15 is a sequence chart illustrating an operation flow of a seat congestion information update of a congestion information notification system.

FIGS. 16A, 16B, and 16C are each diagrams illustrating a display screen of a portable terminal at a seat congestion information update time in an embodiment.

FIG. 17 is a sequence chart illustrating an operation flow of a store congestion information update of a congestion information notification system.

FIG. 18 is a diagram illustrating a display screen of a portable terminal at a store congestion information update time in an embodiment.

FIG. 19 is a flowchart illustrating congestion information notification processing of a server device according to an embodiment.

### DETAILED DESCRIPTION

An embodiment of the present disclosure provides a technology solution to an existing problem in the art related to customer congestion notification systems as applied to food courts and the like. A server and a congestion notification system of an embodiment may be applied to providing more efficient and appropriate congestion notifications to users.

According to one embodiment, a server device for a congestion notification system includes a communication interface configured to receive a request for congestion information from a user terminal, a storage unit for storing congestion information, and a processor. The processor is configured to extract the congestion information from the storage unit after the request is received and to output the extracted congestion information to the user terminal via the communication interface. The congestion information output to the user terminal includes seat congestion information indicating a congestion state of seats shared by a plurality of stores, such as those arranged as food court or the like.

A server device, a congestion information notification system, and a program of certain example embodiments are explained below with reference to the drawings.

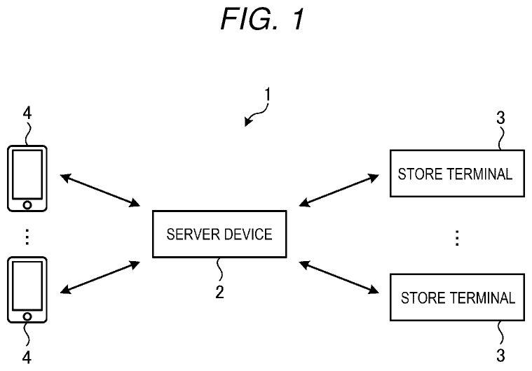

FIG. 1 is a diagram illustrating an overview of a congestion information notification system 1. The congestion information notification system 1 in this embodiment is applied to a food court in a shopping center, for example. The food court is a facility including a plurality of stores with seats shared by customers of the plurality of stores.

The congestion information notification system 1 includes a server device 2, store terminals 3, and portable terminals 4. The server device 2 and the store terminals 3 are communicably connected to each other via a network such as a LAN (Local Area Network). The server device 2 and the portable terminals 4 are communicably connected to each other via the Internet or a network such as a wireless LAN in the shopping center.

The server device 2 tracks a congestion state of the food court and orders from users. The server device 2 is managed by an operating company of the food court, for example. The store terminals 3 are respectively provided in each of the plurality of stores (restaurants) set in the food court. The portable terminals 4 are information communication devices, such as smartphones, carried by users who use the food court.

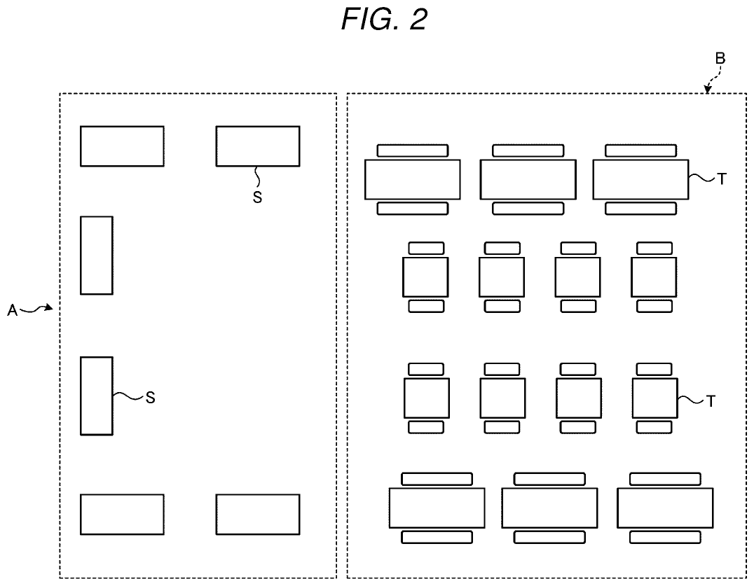

FIG. 2 illustrates a layout of the food court. The food court is an eating and drinking space with shared seats that can used by users. The food court includes a store area A and a seat area B.

A plurality of stores S are provided in the store area A. The stores S each include at least one store terminal 3. The seat area B is an area where users eat and drink items purchased from the stores S. However, there is generally no limit on use of the seat area B and even shoppers who do not purchase items from the stores S may also use the seat area B. A plurality of seats T are provided in the seat area B.

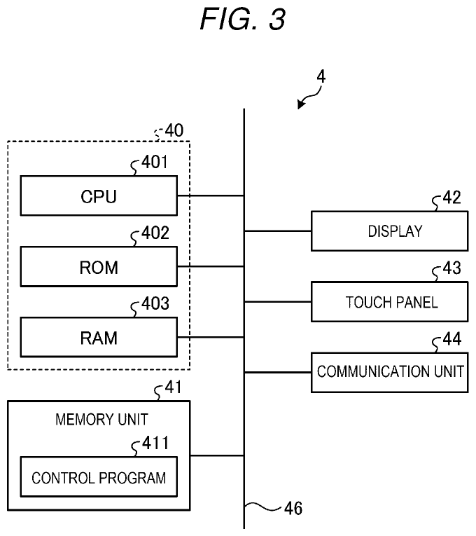

The portable terminal 4 is explained. FIG. 3 is a block diagram illustrating a hardware configuration of a portable terminal 4. The portable terminal 4 includes a control unit 40, a memory unit 41, a display 42, a touch panel 43, and a communication unit 44. The control unit 40, the memory unit 41, the display 42, the touch panel 43, and the communication unit 44 are connected to one another via a bus 45 or the like.

The control unit 40 includes a CPU (Central Processing Unit) 401, a ROM (Read Only Memory) 402, and a RAM (Random Access Memory) 403. The CPU 401, the ROM 402, and the RAM 403 are connected to one another via the bus 45. The CPU 401 controls the overall operations/functioning of the portable terminal 4. The ROM 402 stores various programs such as a program used for driving of the CPU 401 and various data. The RAM 403 is used as a work area of the CPU 401. Various programs and various data stored in the ROM 402 and the memory unit 41 are loaded in the RAM 403. The CPU 401 operates according to a control program stored in the ROM 402 or the memory unit 41 that is loaded in the RAM 403, whereby the control unit 40 executes various kinds of control processing for the portable terminal 4.

The memory 41 can be a storage medium such as an HDD (Hard Disk Drive) or a flash memory and maintains stored content even if a power supply is turned off. The memory unit 41 stores a control program 411.

The control program 411 is, for example, a Web browser for browsing a website of the food court or a control program for executing various kinds of processing for receiving congestion information of the food court.

The display 42 is, for example, a liquid crystal panel and displays various kinds of information. For example, the display 42 displays congestion information, menu information, and the like received from the server device 2. The display 42 displays, for example, a screen for receiving operations of a user such as an input screen for the user to input various kinds of information. The display 42 is an example of a display device.

The touch panel 43 is provided on the surface of the display 42 and provides information corresponding to a position touched by the user to the control unit 40. The touch panel 43 sends, according to operation of the user, information to the control unit 40 for performing member registration for registering as a food court member or information for logging in to the website of the food court.

The communication unit 44 is an interface for communicating with an external device such as the server device 2. The control unit 40 is connected to the external device via the communication unit 44 to be capable of transmitting and receiving information (data) to and from the external device.

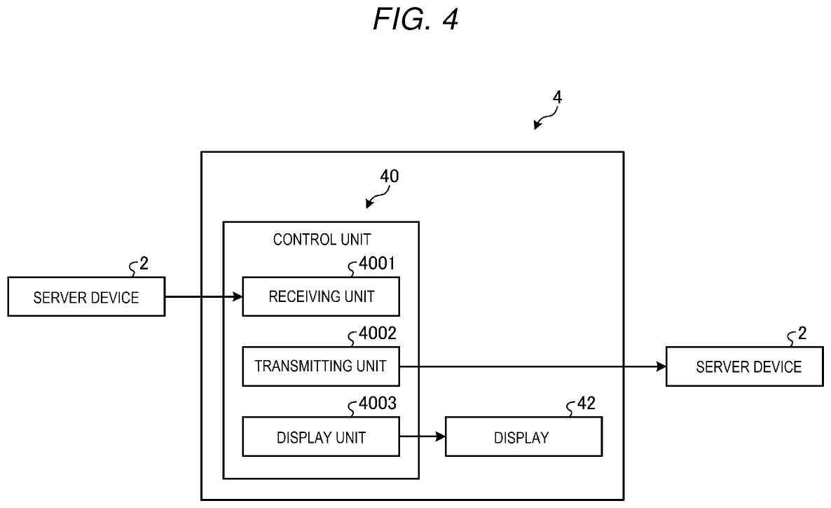

FIG. 4 is a block diagram illustrating certain functional aspects of the portable terminal 4. The CPU 401 operates according to a control program stored in the ROM 402 or the memory 41. By execution of the control program, the control unit 40 functions as a receiving unit 4001, a transmitting unit 4002, and a display unit 4003. In other examples, the corresponding functions may be provided by hardware such as a dedicated circuit. In FIG. 4, two server devices 2 are illustrated primarily for descriptive convenience. However, in other examples, the portable terminal 4 may transmit and receive data to and from just one server device 2 (that is, the two server devices 2 depicted in FIG. 4 may be the same server device 2).

The receiving unit 4001 receives seat congestion information indicating a congestion state of the seats T and store congestion information indicating a congestion state of each of the stores S from a server device 2 in response to a request transmitted by the transmitting unit 4002 to a server device 2. In the following explanation, the seat congestion information and the store congestion information are sometimes collectively referred to as “congestion information”. The receiving unit 4001 receives also various kinds of information such as menu information of the stores S from a server device 2.

The transmitting unit 4002 transmits, to a server device 2, a request for congestion information. The congestion information in this context indicates a congestion state of a food court type facility including a plurality of stores S with shared seats T. Specifically, in this example, the transmitting unit 4002 transmits a first-type request for requesting seat congestion information and a second-type request for requesting store congestion information to the server device 2. The transmitting unit 4002 is capable of transmitting various kinds of information input via the touch panel 43 to the server device 2 according to necessity.

The display unit 4003 causes the display 42 to display the seat congestion information and the store congestion information received by the receiving unit 4001. The display unit 4003 may also cause the display 42 to display other various kinds of information in conjunction with the congestion information.

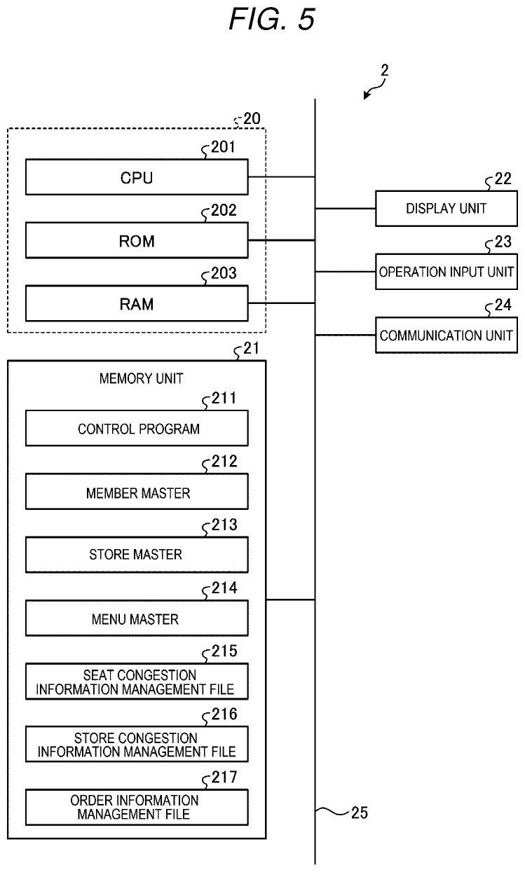

FIG. 5 is a block diagram illustrating a hardware configuration of a server device 2. The server device 2 includes a control unit 20, a memory unit 21, a display unit 22, an operation input unit 23, and a communication unit 24. The control unit 20, the memory unit 21, the display unit 22, the operation input unit 23, and the communication unit 24 are connected to one another via a bus 25 or the like.

The control unit 20 includes a CPU 201, a ROM 202, and a RAM 203. The CPU 201, the ROM 202, and the RAM 203 are connected to one another via the bus 25. The CPU 201 controls the overall operations/functions of the server device 2. The ROM 202 stores various programs such as a program used for driving of the CPU 201 and various data. The RAM 203 is used as a work area of the CPU 201. Various programs and various data stored in the ROM 202 and the memory unit 21 are loaded in the RAM 203. The CPU 201 operates according to a control program stored in the ROM 202 or the memory 21 and loaded in the RAM 203. By execution of the control program, the control unit 20 executes various kinds of control processing for the server device 2.

The memory unit 21 is a storage medium such as an HDD or a flash memory and maintains stored content even if a power supply is turned off. The memory unit 21 stores a control program 211, a member master 212, a store master 213, a menu master 214, a seat congestion information management file 215, a store congestion information management file 216, and an order information management file 217.

The control program 211 is, for example, a control program for managing seat congestion information and store congestion information and a control program for outputting the seat congestion information and the store congestion information to the portable terminal 4.

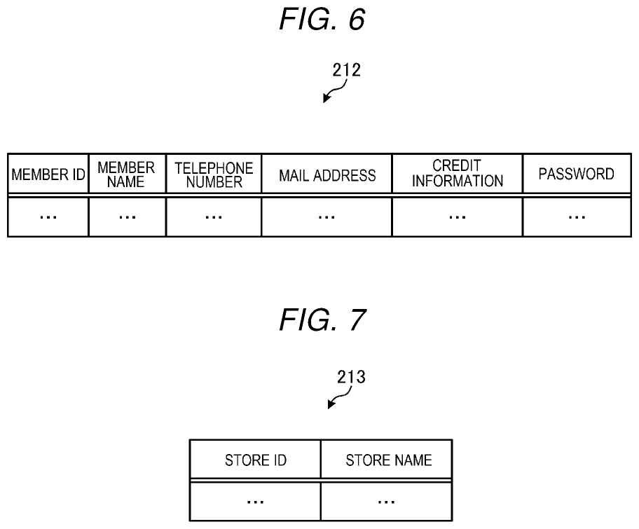

The member master 212 is a master file for managing information concerning members authorized or otherwise eligible to use a congestion information provision service by the server device 2. FIG. 6 is a diagram illustrating a data configuration of the member master 212. In the member master 212, various kinds of information indicating a member ID, a member name, a telephone number, a mail address, credit card information (“credit information”), and a password can be associated. When the user performs a member registration, the server device 2 acquires the information to be registered in the member master 212.

Registration of user credit card information is optional. A user who does not pre-register credit card information may provide credit card information via the portable terminal 4 every time the user executes credit card settlement using the portable terminal 4 or the like. The stored password information is a password provided by the user at member registration or the like. The password is supplied when the member logs in to the food court website.

The store master 213 is a master file for managing information about all the stores S in the food court. FIG. 7 is a diagram illustrating a data configuration of the store master 213. In the store master 213, a store ID (unique to each store S) and a store name are associated with each other. In the store master 213, a store ID and a store name are in association with each other for each of the stores S in the food court. The store master 213 can be updated if a new store S is opened in the food court or a store S in the food court is closed.

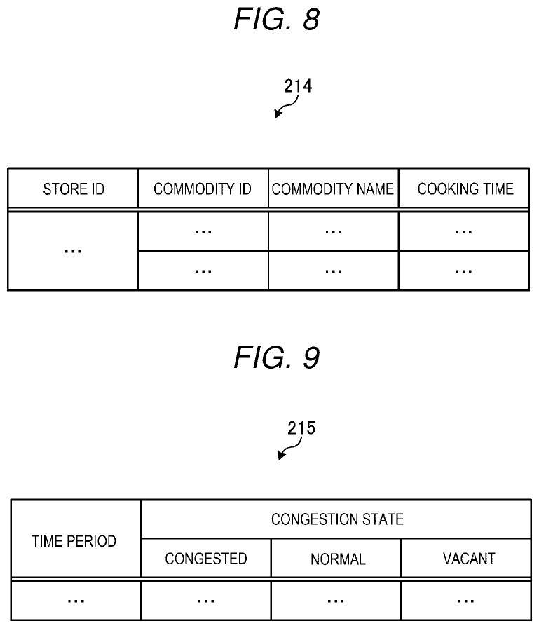

The menu master 214 is a master file for managing menus of all the different stores S in the food court. FIG. 8 is a diagram illustrating a data configuration of the menu master 214. In the menu master 214, respective kinds of information indicating a store ID, a commodity ID, a commodity name, and a cooking time are associated with one another. The server device 2 acquires the information registered in items of the menu master 214 from the store terminals 3 of the stores S. The menu master 214 is an example of a menu-information storing unit.

In this context, the cooking time value is information indicating the estimated time required for the store S to cook (or otherwise prepare) the menu item corresponding to the ordered commodity ID. In the menu master 214, a commodity image (e.g., a picture of the menu item) and any other additional information specific to the commodity ID, or the like can be registered according to necessity.

The seat congestion information management file 215 is a file for tracking a congestion state of the seats T in the food court. In this context, the “congestion state of the seats T” refers to an occupancy level or other measure of seat availability. FIG. 9 is a diagram illustrating a data configuration of the seat congestion information management file 215. In the seat congestion information management file 215, a time period and information indicating or reflecting a congestion state are associated with each other. In the present example, the congestion state information is considered to be one of three different possible values: “congested”, “normal”, and “vacant”. The seat congestion information management file 215 can be updated at any time based on seat congestion information transmitted from the portable terminals 4 of various users. The seat congestion information management file 215 is an example of a congestion-information storing unit. In some examples, the seat congestion information management file 215 may be updated based on an output of a sensor for detecting a congestion state of the seat area B. For example, a camera may be provided for imaging the seat area B to estimate occupancy or seating sensors may be provided in each of the seats T to determine present occupancy levels. The congestion state information is not necessarily limited to the categories of “congested”, “normal”, and “vacant” and other examples may use other categories or measures. For example, just the categories of “congested” and “vacant” may be adopted or additional gradations of occupancy levels may be adopted.

In the time period column of the seat congestion information management file 215, information indicating a particular time period is registered. For example, entries for “12:01 to 12:15” and “12:16 to 12:30” can be registered as information indicating time periods of every 15 minutes. The operating company of the food court can arbitrarily select the time period increment value.

In the present example, the information indicating the congestion state is provided by feedback from registered members. Thus, in the “congested” column, information indicating the number of members feeling that the seats T are presently congested during the relevant time period is registered. Likewise, in the “normal” column, information indicating the number of members feeling the seats T are normally congested (that is, neither particularly congested nor particularly vacant) is registered. In the “vacant” column, information indicating the number of members feeling that the seats T are vacant (that is, widely available) is registered.

The items of the member-perceived congested, normal, and vacant states are updated every time the server device 2 receives seat congestion information from a portable terminal 4. The seat congestion information management file 215 can be considered representing a congestion state of the seats T in every time period. In some examples, the seat congestion information management file 215 may store only information indicating a congestion state at the present time (present time period) rather than storing information about any previous time periods.

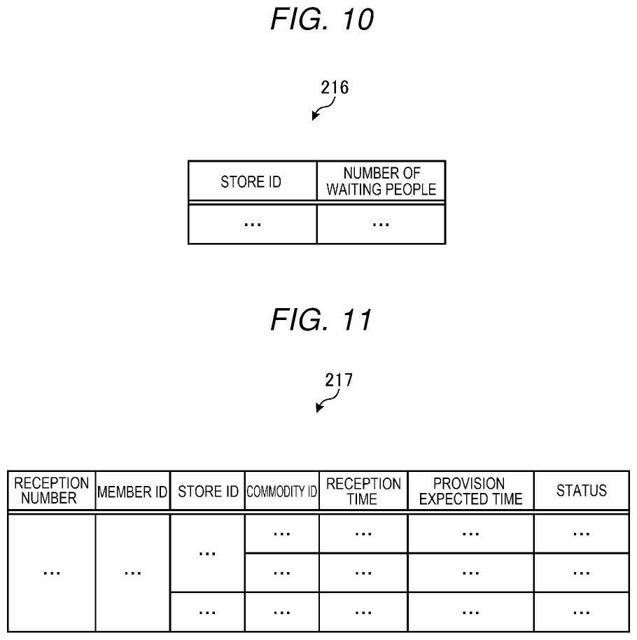

The store congestion information management file 216 is a file for tracking a congestion state of the individual stores S in the food court. FIG. 10 is a diagram illustrating a data configuration of the store congestion information management file 216. In the store congestion information management file 216, a store ID and the number of waiting people at the corresponding store are associated with each other. The store congestion information management file 216 can be updated whenever new information is acquired by the server device 2 from the store terminals 3 of the various stores S. The store congestion information management file 216 is an example of the congestion-information storing unit.

The store ID is, for example, a code number or the like for identifying a particular store S. The value for the number of waiting people reflects the number of customers currently waiting for provision of items at the store S. In some examples, instead of, or in addition to, tracking the number of people waiting at a store S, an expected or estimated service waiting time may be tracked.

The order information management file 217 is a file for tracking, on a per store basis, information concerning the orders placed at the store S. FIG. 11 is a diagram illustrating a data configuration of the order information management file 217. In the order information management file 217, a reception number, a member ID, a store ID, a commodity ID, a reception time, an expected provision time, and a status are associated with one another.

The reception number is for identifying the order information received by the server device 2 from a portable terminal 4. If the server device 2 receives the order information from the portable terminal 4 and settlement relating to the order information is completed, the server device 2 dispenses a reception number and registers the reception number in the item of the reception number column. A new reception number is dispensed every time the order information is received and may sometimes include orders placed at a plurality of stores S.

The member ID is for identifying the member who has placed an order. The store ID is for identifying the store S providing an ordered item included in the order information (also referred to as “ordered commodity” as well). The commodity ID is for identifying the particular items that have been ordered.

The reception time is information indicating time when the server device 2 received the order from the portable terminal 4. The expected provision time is information indicating the expected time when the ordered commodity will be provided to the customer (member). The server device 2 in this example calculates an expected provision time based on a cooking time for the ordered commodity and information indicating the number of already waiting people at the store S providing the ordered commodity. The information regarding item cooking time and the number of waiting people may be provided by the store terminal 3 of the store S providing the ordered commodity.

The status of the received order is registered in the “STATUS” field. For example, that a status may be “cooking” (in progress) or “commodity provided” (completed). The status is updated based on, for example, information acquired by the server device 2 from the store terminals 3. The information indicating the reception time, the expected provision time, and the status can be registered for each of the ordered commodities.

If the stores S are enabled to individually receive orders, the server device 2 can acquire information concerning orders from the store terminals 3 of the stores S and update the order information management file 217 as appropriate.

Referring back to FIG. 5, a hardware configuration of the server device 2 is explained.

The display unit 22 can be a liquid crystal panel or the like and displays various kinds of information. For example, the display unit 22 displays an input screen permitting the inputting of various kinds of information.

The operation input unit 23 can be a keyboard, a touch panel provided on the surface of the display unit 22, or the like. The operation input unit 23 sends, based on operations of an operator/administrator, various kinds of information such as information for setting a time period of the seat congestion information management file 215 to the control unit 20.

The communication unit 24 is an interface for communicating with external devices such as the store terminals 3 and the portable terminals 4. The control unit 20 is connected to the external devices via the communication unit 24 to be capable of transmitting and receiving information (data) to and from the external devices.

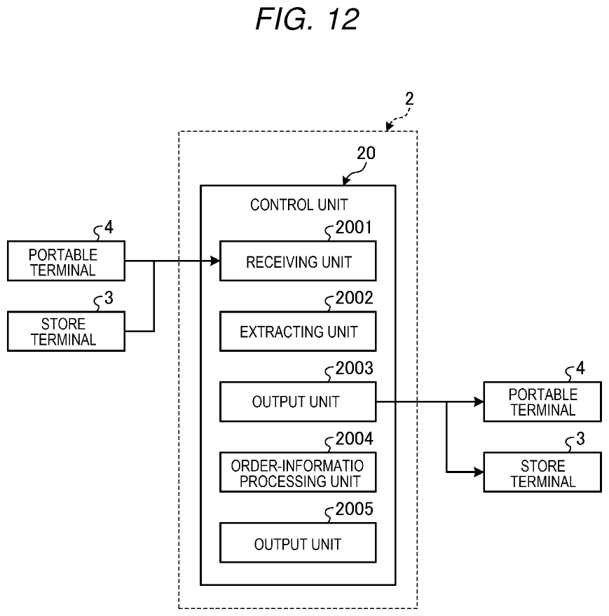

FIG. 12 is a block diagram illustrating functional aspects of the server device 2. The CPU 201 operates as a control unit 20 according to a control program stored in the ROM 202 or the memory unit 21. The control unit 20 functions as a receiving unit 2001, an extracting unit 2002, an output unit 2003, an order-information processing unit 2004, and an updating unit 2005. These functions may be provided or implemented by hardware such as a dedicated circuit in some examples rather than by programmed functions of CPU 201 or the like. In FIG. 12, two server devices 2 are illustrated. However, one server device 2 may be used in some examples, and the depiction in FIG. 12 is primarily for purposes of explanation of interactions between systems rather than arrangements of the various components.

The receiving unit 2001 receives congestion information indicating the congestion state of a facility including a plurality of stores S and seats T that are shared by customers of the plurality of stores S. For example, the receiving unit 2001 receives a request for seat congestion information (“a first-type request” or a request for store congestion information (“a second-type request”) from a portable terminal 4. The second-type request may request congestion information for only a specific store or may request congestion information of multiple or all the stores. In this embodiment, the receiving unit 2001 separately receives the request for the seat congestion information and the request for the store congestion information. However, the receiving unit 2001 may receive the seat congestion information and the store congestion information as one, combined request in other examples.

The receiving unit 2001 receives various kinds of information from the portable terminal 4. For example, the receiving unit 2001 receives, from the portable terminal 4, seat congestion information input to the portable terminal 4 by a user and order information for the user to order a commodity (item) from a store. The seat congestion information received by the receiving unit 2001 is, for example, information indicating “vacant”, “normal”, or “congested” as estimated or perceived by the user. The order information received by the receiving unit 2001 is information including a member ID, a store ID, and a commodity ID indicating the ordered commodity. The seat congestion information indicates a congestion state of the facility.

The receiving unit 2001 receives various information from the store terminal 3. For example, the receiving unit 2001 receives store congestion information and cooking completion notifications from the store terminals 3. The store congestion information indicates the number of waiting people (the number of customers waiting for provision of commodities), a waiting time (an expected time until an ordered commodity is received), the number of received orders, or the number of unfilled orders received but are not yet completed. The store congestion information may be formed based on information generated by combining these kinds of information. The cooking completion notification is information indicating that cooking of a commodity ordered by a user has been completed.

The extracting unit 2002 extracts, from the congestion-information storing unit that stores congestion information, seat congestion information indicating a congestion state of the seats T and store congestion information indicating a congestion state of the store S. Specifically, the extracting unit 2002 extracts seat congestion information from the seat congestion information management file 215. For example, if the receiving unit 2001 receives the first-type request, the extracting unit 2002 refers to the seat congestion information management file 215. The extracting unit 2002 extracts, as the seat congestion information, the congestion state for which the number of registered people is the largest in the time period matching the time period during which the first-type request was received or the time period immediately before the present time period. The value of the congestion state to be extracted is any one of “congested”, “normal”, and “vacant” set as the items in the seat congestion information management file 215.

The extracting unit 2002 extracts store congestion information from the store congestion information management file 216. For example, if the receiving unit 2001 receives the second-type request, the extracting unit 2002 refers to the store congestion information management file 216 and extracts, as the store congestion information, information indicating the number of waiting people in the stores S. If a store ID designating the store S is included in the second-type request, the extracting unit 2002 extracts information indicating the number of waiting people corresponding to the store ID from the store congestion information management file 216 and extracts a commodity ID and the like corresponding to the store ID from the menu master 214.

After the receiving unit 2001 receives a request for congestion information, the output unit 2003 outputs the seat congestion information and the store congestion information extracted by the extracting unit 2002. Specifically, if the receiving unit 2001 receives the first-type request, the output unit 2003 outputs the seat congestion information to the portable terminal 4. If the receiving unit 2001 receives the second-type request, the output unit 2003 outputs the store congestion information to the portable terminal 4. In other words, it can be considered that, as a condition for the output unit 2003 to output two kinds of information of the seat congestion information and the store congestion information, reception of a request for congestion information including the first-type request and the second-type request by the receiving unit 2001 is set. The output unit 2003 separately outputs the seat congestion information and the store congestion information. However, the output unit 2003 may output the seat congestion information and the store congestion information at a time.

In this embodiment, the extracting unit 2002 extracts the seat congestion information and the output unit 2003 outputs the extracted seat congestion information after the receiving unit 2001 receives the first-type request. The extracting unit 2002 extracts the store congestion information and the output unit 2003 outputs the extracted store congestion information after the receiving unit 2001 receives the second-type request. However, without being limited to these kinds of processing, for example, the extracting unit 2002 may periodically extract the seat congestion information and the store congestion information and the output unit 2003 may output the seat congestion information or the store congestion information extracted most recently at a point in time when the receiving unit 2001 receives the first-type request and the second-type request.

The output unit 2003 outputs other information to the portable terminal 4. For example, the output unit 2003 outputs an order completion notification indicating that an order by the order information is completed to the portable terminal 4 together with information indicating a reception number for identifying the order information and an expected provision time of the ordered commodity. The output unit 2003 outputs a cooking completion notification indicating that cooking of the ordered commodity is completed to the portable terminal 4 together with information indicating the reception number and the commodity name.

The output unit 2003 outputs various kinds of information to the store terminal 3. For example, the output unit 2003 outputs a commodity ID and the like included in order information received from the portable terminal 4 to the store terminal 3 of the store S that sells a commodity identified by the commodity ID.

The order-information processing unit 2004 executes processing relating to order information received by the receiving unit 2001 from the portable terminal 4. For example, the order-information processing unit 2004 communicates with a settlement server (not illustrated) managed by a settlement agent and executes settlement related processing for performing settlement relating to the order information received by the receiving unit 2001. The order-information processing unit 2004 can execute processing relating to cashless settlement such as credit card settlement and two-dimensional code settlement as the settlement related processing.

The order-information processing unit 2004 updates the order information management file 217 based on the order information received by the receiving unit 2001. More specifically, the order-information processing unit 2004 dispenses a reception number to the order information received by the receiving unit 2001 and registers the reception number in the order information management file 217. The order-information processing unit 2004 registers, in the order information management file 217, a member ID for identifying a user whose order is received, a store ID for identifying the store S that sells an ordered commodity, a commodity ID for identifying the ordered commodity, and a reception time when the order information was received. Further, the order-information processing unit 2004 extracts a cooking time of the ordered commodity by reference to the menu master 214 and registers an expected provision time calculated from the cooking time, the reception time, and the like. In addition, the order-information processing unit 2004 updates a status based on information received from the store terminal 3.

The updating unit 2005 updates the seat congestion information management file 215 based on seat congestion information received by the receiving unit 2001 from the portable terminal 4. The updating unit 2005 updates the store congestion information management file 216 based on store congestion information received by the receiving unit 2001 from the store terminal 3. It can be considered that a congestion state of the seats T and a congestion state of the store S are managed by the processing of the updating unit 2005.

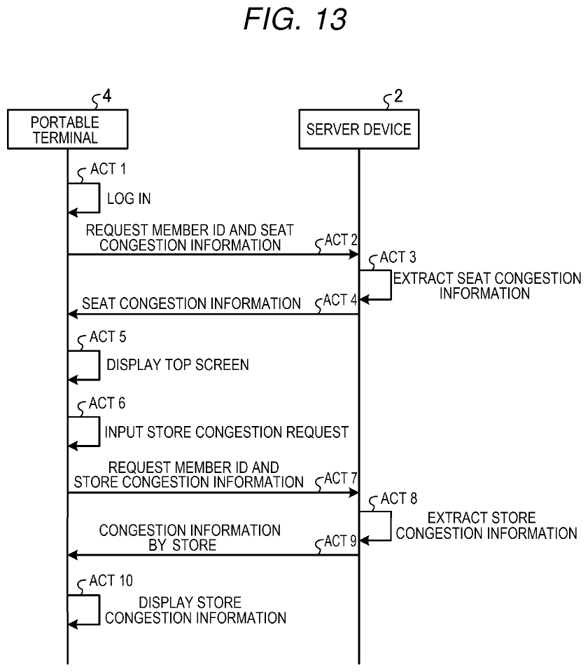

The operation of the congestion information notification system 1 is explained. First, an operation at the time when the server device 2 provides congestion information to the portable terminal 4 of the user is explained. FIG. 13 is a flowchart illustrating a flow of an operation at a congestion information notification time of the congestion information notification system 1.

The user operates the portable terminal 4 and logs in to the Web site of the food court. For example, the portable terminal 4 reads a two-dimensional code displayed in the shopping center to thereby execute processing for logging in (Act 1). If the processing for logging in such as an input of a password is executed, the portable terminal 4 outputs a member ID of a member carrying the portable terminal 4 and a request (a first-type request) for seat congestion information to the server device 2 (Act 2).

If receiving the first-type request, the server device 2 extracts seat congestion information by reference to the seat congestion information management file 215 (Act 3). The seat congestion information to be extracted is an item (any one of “congested”, “normal”, and “vacant”) in which the number of registered people is the largest in a time period when the first-type request was received. The server device 2 outputs the extracted seat congestion information to the portable terminal 4 of the member identified by the member ID (Act 4).

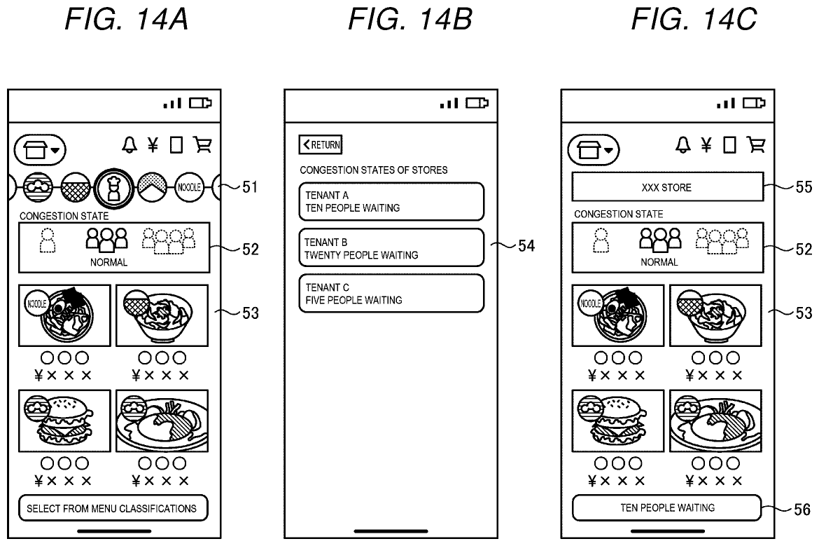

The portable terminal 4 displays a screen (a top screen) including indication of the seat congestion information acquired from the server device 2 (Act 5). FIG. 14A is a diagram illustrating the top screen displayed on the portable terminal 4. A store selection region 51, a seat congestion information region 52, and a menu region 53 are formed on the top screen.

In the store selection region 51, icons of the stores S open in the food court are displayed. The icons also function as selection buttons for selecting the stores S. The seat congestion information acquired from the server device 2 is displayed in the seat congestion information region 52. In the seat congestion information region 52, three display regions showing “vacant”, “normal”, and “congested” are formed in order from the left in the figure. A display region corresponding to the congestion information acquired from the server device 2 is bright and the other two regions are grayed out. In FIG. 14A, since the seat congestion information acquired from the server device 2 is “normal”, in the portable terminal 4, the display region showing “normal” is bright and the other two display regions are grayed out. In the menu region 53, for example, menu items recommended by the stores S are displayed. The recommended menu items displayed on the top screen can be optionally set.

Referring back to FIG. 13, if the request for store congestion information (the second-type request) is input to the portable terminal 4 (Act 6), the portable terminal 4 outputs the member ID and the second-type request to the server device 2 (Act 7). The user can select a request for congestion information of all the stores S or a request for congestion information of a specific store S. In FIG. 14A, the user can request the congestion information of all the stores S by touching the seat congestion information region 52 and can request the congestion information of the specific store S by touching the icon of any one of the stores S in the store selection region 51.

If receiving the second-type request, the server device 2 extracts store congestion information by reference to the store congestion information management file 216 (Act 8). The store congestion information to be extracted is, for example, information indicating the number of waiting people. If the received second-type request is the request for the congestion information of all the stores S, the server device 2 extracts the store congestion information of all the stores S. If the received second-type request is the request for the congestion information of the specific store S, the server device 2 extracts the store congestion information of the specific store S and extracts menu information of the specific store S from the menu master 214.

The server device 2 outputs the extracted store congestion information to the portable terminal 4 of a member identified by the member ID (Act 9). If the received second-type request is the request for the congestion information of the specific store S, the server device 2 outputs the extracted menu information as well to the portable terminal 4.

The portable terminal 4 displays the store congestion information acquired from the server device 2 (Act 10). FIG. 14B is a display screen in the case in which the portable terminal 4 acquires the congestion information of all the stores S. A congestion information region by store 54 is formed on the display screen. In the congestion information region by store 54, store congestion information associating a store name and the number of waiting people is displayed for the store S in which the number of waiting people occurs at a point in time when the second-type request is received.

FIG. 14C is a display screen in the case in which the portable terminal 4 acquires the congestion information of the specific store S. On the display screen, a store name region 55, the seat congestion information region 52, the menu region 53, and a store congestion information region 56 are formed.

In the store name region 55, a name of the store S specified by the second-type request is displayed. In the seat congestion information region 52, the same information as the information displayed in the seat congestion information region 52 on the top screen is displayed. In the menu region 53, a menu of the store S displayed in the store name region 55 is displayed. The portable terminal 4 can display all menu items of the store S displayed in the store name region 55 by scrolling the menu region 53.

According to the operation illustrated in FIG. 13 explained above, the congestion information notification system 1 can provide a congestion state of the seats T and a congestion state of the store S in the food court to the user. In this embodiment, the server device 2 receives the first-type request and the second-type request at different timings. However, the server device 2 may receive the first-type request and the second-type request as one request. The server device 2 may output the seat congestion information and the store congestion information at the same timing.

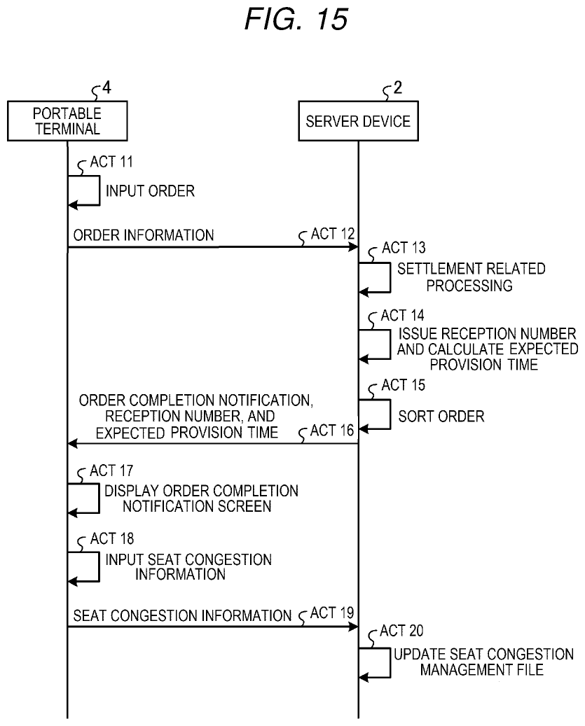

Subsequently, an operation at the time when the server device 2 collects seat congestion information from the portable terminal 4 of the user is explained. FIG. 15 is a sequence chart illustrating a flow of an operation at a seat congestion information update time.

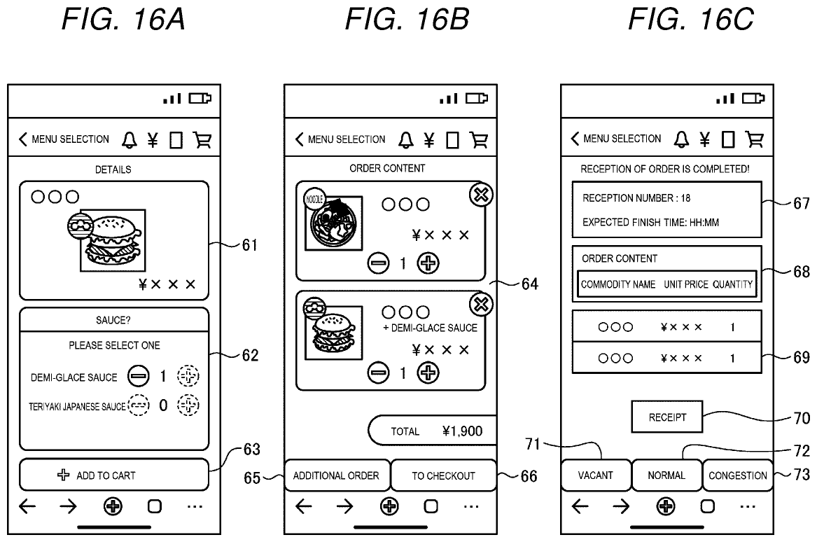

The user can operate the portable terminal 4 and order a commodity irrespective of the inside or the outside of the food court. An input relating to the order is performed to the portable terminal 4 by the user (Act 11). FIG. 16A is a diagram illustrating an order input screen. The order input screen is displayed by, for example, the user touching a commodity displayed in the menu region 53 in FIG. 14C. A commodity information region 61, an additional information region 62, and an order input region 63 are formed on the order input screen.

In the commodity information region 61, information concerning a commodity designated by the user is displayed. The information concerning the commodity to be displayed is, for example, a commodity name, a commodity image, and a price. The additional information region 62 functions as an input screen region to which additional information of the commodity is input. The additional information to be input is additional information concerning the commodity such as a type of sauce and a type of a volume such as large serving or normal serving. The additional information is set in advance for each of commodities. The order input region 63 functions as an input screen region for specifying, as an ordered commodity, the commodity displayed in the commodity information region 61.

If the user touches the order input region 63 and inputs, as the ordered commodity, the commodity displayed in the commodity information region 61, the portable terminal 4 displays a confirmation screen illustrated in FIG. 16B. An ordered commodity region 64, an additional order button 65, and a checkout button 66 are formed on the confirmation screen.

In the ordered commodity region 64, commodity information, a total amount, and the like of the ordered commodity selected by the user are displayed. The additional order button 65 is operated if order information is further input in addition to the commodity displayed in the ordered commodity region 64. If the additional order button 65 is operated, the portable terminal 4 displays, for example, the top screen or a menu screen of the store S that sells an ordered commodity input immediately before the additional order button 65 is operated. The checkout button 66 is a button for deciding an order and instructing settlement.

Referring back to FIG. 15, if the order is decided, the portable terminal 4 outputs the order information to the server device 2 (Act 12). The order information output from the portable terminal 4 includes a member ID, a commodity ID for identifying an input ordered commodity, and a store ID for identifying the store S that provides the ordered commodity.

The server device 2 executes the settlement related processing based on the order information acquired from the portable terminal 4 (Act 13). For example, the server device 2 reads credit card information corresponding to the acquired member ID from the member master 212, communicates with the settlement server (not illustrated) managed by the settlement agent, and executes the settlement related processing for performing settlement relating to the ordered commodity. If the user did not register credit card information in the member master 212, the server device 2 outputs an input request for credit card information to the portable terminal 4 as a part of the settlement related processing.

The server device 2 dispenses a reception number to the received order information and calculates an expected provision time for the ordered commodity (Act 14). Subsequently, the server device 2 executes order sorting processing based on the received order information (Act 15). The order sorting processing is processing for sorting an ordered commodity indicated by the order information received by the server device 2 to each of the stores S that provide the ordered commodity. As explained in detail below, the server device 2 outputs information relating to the sorted ordered commodity to the store terminals 3 of the stores S.

After finishing the settlement related processing and the like, the server device 2 outputs information indicating an order completion notification indicating that the reception of the order is completed, the dispensed reception number, and the calculated expected provision time to the portable terminal 4 (Act 16).

The portable terminal 4 displays an order completion notification screen based on the information acquired from the server device 2 (Act 17). FIG. 16C is a diagram illustrating the order completion notification screen. A message region 67, a reception information region 68, an order information region 69, a receipt button 70, a vacant button 71, a normal button 72, a congestion button 73, and the like are formed on the order completion notification screen.

In the message region 67, a message indicating that the reception of the order is completed is displayed. In the reception information region 68, the reception number dispensed by the server device 2 and the expected provision time calculated by the server device 2 are displayed. The received order content is displayed in the order information region 69. For example, in the order information region 69, a commodity name, a price, and the number of articles of the ordered commodity are displayed in association with one another.

The receipt button 70 is a button for receiving an electronic receipt. If the receipt button 70 is operated, a receipt issue request is output to the server device 2. The server device 2 acquiring the issue request outputs a receipt issue instruction to the store terminals 3 of the stores S that provide the ordered commodity. The store terminals 3 acquiring the receipt issue instruction transmits electronic receipts to the portable terminal 4 through the server device 2 or directly.

The vacant button 71, the normal button 72, and the congestion button 73 are buttons for inputting seat congestion information. The user operates any one of the vacant button 71, the normal button 72, and the congestion button 73 based on a congestion state of the seats T in the food court felt by the user. Consequently, the server device 2 becomes capable of collecting seat congestion information input by the user. The portable terminal 4 may display a message for urging an input of congestion information on the order completion notification screen or may perform setting to return to a top page if that the seat congestion information is input. Consequently, the server device 2 can collect a lot of seat congestion information.

Referring back to FIG. 15, if seat congestion information is input (Act 18), the portable terminal 4 sends the input seat congestion information to the server device 2 (Act 19). The server device 2 updates the seat congestion information management file 215 based on the seat congestion information sent from the portable terminal 4 (Act 20). For example, in the seat congestion information management file 215, the server device 2 adds one to the number of people indicating the corresponding congestion state during the present time period based on the congestion information acquired from the portable terminal 4. The server device 2 may output information for imparting a privilege such as point impartment to the portable terminal 4 that transmits the seat congestion information. Consequently, it is possible to urge the user to input the seat congestion information.

According to the operation illustrated in FIG. 15 explained above, the server device 2 can collect the seat congestion information from the portable terminal 4 of the user who orders the commodity and track the congestion state of the seats T in the food court.

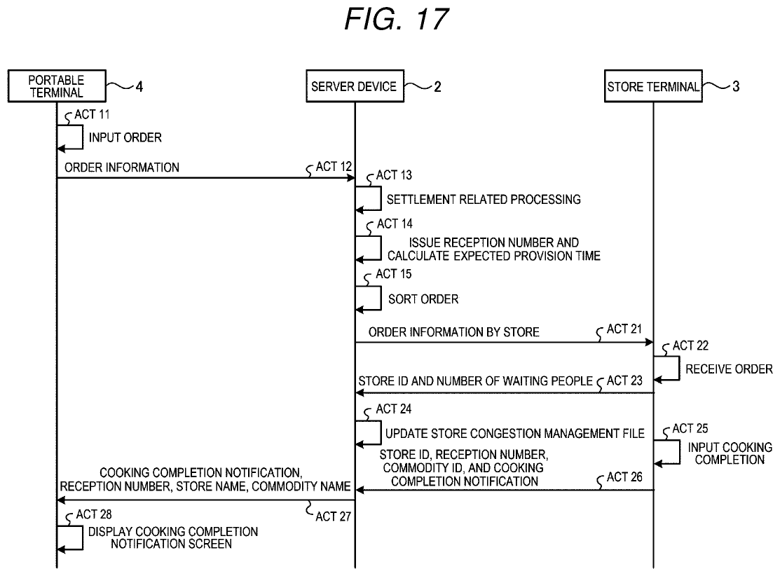

Subsequently, an operation at the time when the server device 2 collects store congestion information from the store terminal 3 is explained. FIG. 17 is a sequence chart illustrating a flow of an operation at a store congestion information update time. In FIG. 17, since processing in Act 11 to Act 15 is the same as the processing illustrated in FIG. 15, redundant explanation of the processing is omitted.

After executing the order sorting processing in Act 15, the server device 2 outputs order information by store to the store terminal 3 in the store S that sells an ordered commodity (Act 21). The order information by store output from the server device 2 is information including a member ID of a user who makes an order, a reception number issued for order information, and a commodity ID indicating the ordered commodity.

The store terminal 3 executes order reception processing on the order information by store acquired from the server device 2 (Act 22). The order reception processing is, for example, outputting a print instruction for the ordered commodity indicated by the order information by store to a kitchen printer (not illustrated) included in the store S. After executing the order reception processing, the store terminal 3 outputs a store ID of the store S where the store terminal 3 is provided and information indicating the number of waiting people, that is, store congestion information to the server device 2 (Act 23). The information indicating the number of waiting people output by the store terminal 3 may be managed by the store terminal 3 and be automatically output or may be output by manual input by a store clerk of the store S.

The server device 2 updates the store congestion information management file 216 based on the store congestion information acquired from the store terminal 3 (Act 24). Specifically, in the store congestion information management file 216, the server device 2 rewrites, based on the information indicating the number of waiting people acquired from the store terminal 3, the item of the number of waiting people corresponding to the store ID acquired from the store terminal 3.

Thereafter, after cooking of the ordered commodity is completed in the store S, cooking completion is input to the store terminal 3 (Act 25). When the cooking completion is input, the store terminal 3 outputs the store ID indicating the store S where the store terminal 3 is provided, a reception number, a commodity ID of the ordered commodity, and a cooking completion notification indicating that the cooking is completed to the server device 2 (Act 26).

The server device 2 transmits, by electronic mail or the like, to the portable terminal 4, together with the cooking completion notification, information indicating the reception number, a commodity name of the ordered commodity, and a store name of the store S that provides the ordered commodity (Act 27). The server device 2 reads out, from the member master 212, a mail address of the user and transmits the information indicating the cooking completion notification, the reception number, the commodity name, and the store name to the portable terminal 4. The server device 2 may output the information indicating the cooking completion notification, the reception number, the commodity name, and the store name after cooking of all commodities ordered by the user is completed or may output the information every time cooking of an individual commodity ordered by the user is completed.

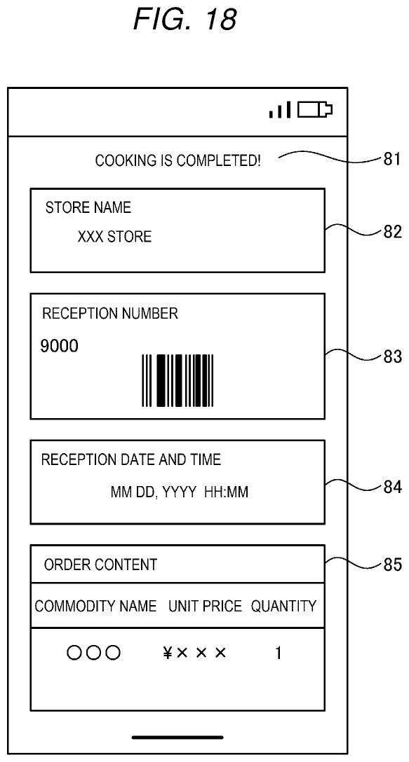

The portable terminal 4 displays a cooking completion notification screen based on the information acquired from the server device 2 (Act 28). FIG. 18 is a diagram illustrating the cooking completion notification screen. A message region 81, a store name region 82, a reception number region 83, a reception date and time region 84, an order content region 85 and the like are formed on the cooking completion notification screen.

In the message region 81, a message indicating that cooking in the store S is completed for an ordered commodity is displayed. In the store name region 82, a name of the store S that provides the commodity for which the cooking is completed is displayed. In the reception number region 83, a reception number issued for order information including the ordered commodity for which the cooking is completed is displayed. In the reception number region 83, a barcode indicating that the user received the ordered commodity is also displayed. The store S can change a status of the ordered commodity managed by the store terminal 3 to “provided” by reading the barcode if the cooked commodity is provided to the user.

In the reception date and time region 84, an order reception date and time of the commodity for which the cooking is completed is displayed. In the order content region 85, a commodity name, a price, and the number of articles of the ordered commodity for which the cooking is completed are displayed in association with one another. The user who received the cooking completion notification can go to the store S displayed in the store name region 82 to receive the commodity.

The vacant button 71, the normal button 72, and the congestion button 73 for inputting the seat congestion information displayed on the order completion notification screen illustrated in FIG. 16C may be displayed on the cooking completion notification screen illustrated in FIG. 18 in some examples. After the cooking completion notification screen is displayed, the user goes to the store S to receive the ordered commodity. Therefore, the user is considered to be located in the food court when the cooking completion notification screen is displayed. Accordingly, it can be expected that more accurate seat congestion information will input at this time by displaying the vacant button 71, the normal button 72, and the congestion button 73 on the cooking completion notification screen.

According to the operation illustrated in FIG. 17 explained above, the server device 2 can collect the store congestion information from the store terminal 3 and manage a congestion state of the stores S in the food court.

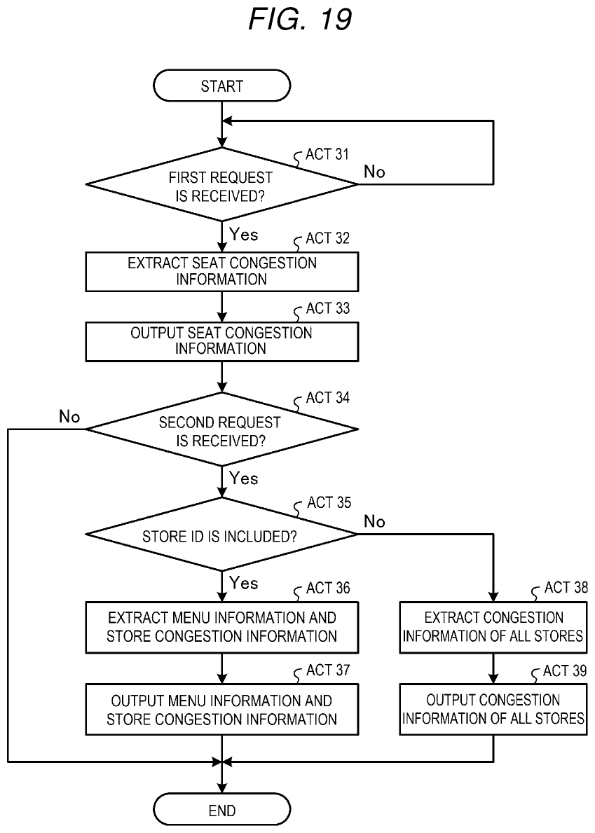

Congestion information notification processing by the control unit 20 of the server device 2 is explained. FIG. 19 is a flowchart illustrating the congestion information notification processing by the control unit 20 of the server device 2.

The control unit 20 determines whether the receiving unit 2001 received a first-type request, that is, a request for seat congestion information (Act 31) and, if the receiving unit 2001 did not receive the first-type request (N in Act 31), returns to the processing in Act 31 and stays on standby.

If the receiving unit 2001 receives the first-type request (Y in Act 31), the extracting unit 2002 extracts present seat congestion information by reference to the seat congestion information management file 215 (Act 32). The output unit 2003 outputs the seat congestion information extracted by the extracting unit 2002 to the portable terminal 4 that outputted the first-type request (Act 33).

Subsequently, the control unit 20 determines whether the receiving unit 2001 received a second-type request, that is, a request for store congestion information (Act 34) and, if the receiving unit 2001 does not receive the second-type request for a predetermined time (N in Act 34), ends the congestion information notification processing.

If the receiving unit 2001 receives the second-type request (Y in Act 34), the extracting unit 2002 determines whether a store ID for designating a specific store S is included in the second-type request (Act 35). If the store ID is included in the second-type request (Y in Act 35), the extracting unit 2002 extracts, from the menu master 214, a menu of the store S identified by the store ID and extracts, from the store congestion information management file 216, store congestion information of the store S identified by the store ID (Act 36). The output unit 2003 outputs the menu information and the store congestion information extracted by the extracting unit 2002 to the portable terminal 4 that output the second-type request (Act 37). The control unit 20 ends the congestion information notification processing.

If the store ID is not included in the second-type request received by the receiving unit 2001 (N in Act 35), the extracting unit 2002 extracts store congestion information of all the stores S from the store congestion information management file 216 (Act 38). The output unit 2003 outputs the store congestion information extracted by the extracting unit 2002 to the portable terminal 4 that output the second-type request (Act 39). The control unit 20 ends the congestion information notification processing.

According to the congestion information notification processing, the server device 2 can output the seat congestion information indicating the congestion state of the seats T of the food court and the store congestion information indicating the congestion state of the stores S in the food court to a portable terminal 4 that requests the congestion information.

The server device 2 in the embodiment includes a receiving unit 2001 that receives a request for congestion information, a extracting unit 2002 that extracts seat congestion information indicating the congestion state of shared seats (seats T) and store congestion information indicating the congestion state of the stores S from the congestion-information storing unit (more particularly, the seat congestion information management file 215 and the store congestion information management file 216), and an output unit 2003 that outputs the seat congestion information and the store congestion information extracted by the extracting unit 2002 upon request.

Consequently, the server device 2 can output the seat congestion information and the store congestion information to the portable terminal 4 of the user. Accordingly, the user is capable of learning the congestion state of the seats T and the congestion state of the stores S. Therefore, the server device 2 can improve convenience of users who use a facility such as a food court.

The receiving unit 2001 of the server device 2 in an embodiment is capable of receiving a first-type request and a second-type request. If the receiving unit 2001 receives the first-type request, the output unit 2003 outputs the seat congestion information. If the receiving unit 2001 receives the second-type request, the output unit 2003 outputs the store congestion information.

As such, the server device 2 outputs the store congestion information upon request after outputting the seat congestion information to the portable terminal 4. In other word, the server device 2 outputs the seat congestion information first and does not output the store congestion information unless the second-type request is received. Accordingly, the server device 2 can reduce unnecessary information extraction processing and output processing and can realize more efficient processing.

The receiving unit 2001 of the server device 2 in an embodiment is capable of receiving identification information for identifying a store S. If the receiving unit 2001 receives such identification information in conjunction with a second-type request or the like, the output unit 2003 can output congestion information for just the specific store S identified by the identification information.

Consequently, the server device 2 can operate to output only congestion information of a specific store S as requested by the user of the portable terminal 4. Accordingly, it is possible to display, on the portable terminal 4 of the user, a congestion state of only the store S particularly desired by the user. It is thus possible to further improve convenience of the user.

In addition, if the receiving unit 2001 receives identification information, the extracting unit 2002 of the server device 2 in an embodiment extracts menu information of the store S identified by the identification information from the menu-information storing unit (more specifically, from the menu master 214). The output unit 2003 outputs the menu information extracted by the extracting unit 2002 and congestion information of the store S identified by the identification information received by the receiving unit 2001.

Consequently, congestion information for the specific store S which is requested by the user, can be output in conjunction with the corresponding menu information to the portable terminal 4. Accordingly, a congestion state and a menu of the store S selected by the user can be displayed on the portable terminal 4 of the user to further improve convenience of the user.

The control programs used in the server device 2, the store terminal 3, and the portable terminal 4 in an embodiment may be provided by being recorded in a non-transitory, computer-readable recording medium such as a CD-ROM or the like. The control programs executed in the server device 2, the store terminal 3, and the portable terminal 4 may be stored on a computer connected to a network, such as the Internet, and downloaded or otherwise provided through the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server device for a congestion notification system, the server device comprising:
a communication interface configured to receive a request for congestion information from a user terminal;
a storage unit for storing congestion information; and
a processor configured to:
extract the congestion information from the storage unit after the request is received, and
output the extracted congestion information to the user terminal via the communication interface, wherein
the congestion information output to the user terminal includes seat congestion information indicating a congestion state of seats shared by a plurality of stores.

2. The server device according to claim 1, wherein the congestion information output to the user terminal further includes store congestion information indicating a congestion state of at least one store in the plurality of stores.

3. The server device according to claim 1, wherein the congestion information output to the user terminal further includes store congestion information indicating a congestion state of each store in the plurality of stores.

4. The server device according to claim 1, wherein
the communication interface is further configured to receive a menu item order from the user terminal for an item sold by a store in the plurality of stores, and
the processor is further configured to output information corresponding to the menu item order to the store via the communication interface.

5. The server device according to claim 1, wherein the processor is further configured to:
extract store congestion information indicating a congestion state of at least one store in the plurality of stores from the storage unit upon receiving a second request for congestion information from the user terminal, and
output the extracted store congestion information to the user terminal via the communication interface.

6. The server device according to claim 1, wherein
the communication interface is further configured to receive information indicating a seat congestion state of the seats shared by the plurality of stores from the user terminal, and
the processor is further configured to store the received information indicating the seat congestion state in the storage unit.

7. The server device according to claim 1, wherein
the communication interface is further configured to receive information indicating a store congestion state of at least one store of the plurality of stores from a store terminal at the at least one store, and
the processor is further configured to store the received information indicating the store congestion state in the storage unit.

8. The server device according to claim 1, wherein the storage unit stores menu information for each store in the plurality of stores.

9. A congestion information notification system, comprising:
a portable terminal; and
a server device including:
a communication interface configured to receive a request for congestion information from the portable terminal;
a storage unit for storing congestion information; and
a processor configured to:
extract the congestion information from the storage unit after the request is received, and
output the extracted congestion information to the portable terminal via the communication interface, wherein
the congestion information output to the portable terminal includes seat congestion information indicating a congestion state of seats shared by a plurality of stores.

10. The system according to claim 9, wherein the congestion information output to the portable terminal further includes store congestion information indicating a congestion state of at least one store in the plurality of stores.

11. The system according to claim 9, wherein the congestion information output to the portable terminal further includes store congestion information indicating a congestion state of each store in the plurality of stores.

12. The system according to claim 9, wherein
the communication interface is further configured to receive a menu item order from the portable terminal for an item sold by a store in the plurality of stores, and
the processor is further configured to output information corresponding to the menu item order to the store via the communication interface.

13. The system according to claim 9, wherein the processor is further configured to:
extract store congestion information indicating a congestion state of at least one store in the plurality of stores from the storage unit upon receiving a second request for congestion information from the portable terminal, and
output the extracted store congestion information to the portable terminal via the communication interface.

14. The system according to claim 9, wherein
the communication interface is further configured to receive information indicating a seat congestion state of the seats shared by the plurality of stores from the portable terminal, and
the processor is further configured to store the received information indicating the seat congestion state in the storage unit.

15. The system according to claim 9, wherein
the communication interface is further configured to receive information indicating a store congestion state of at least one store of the plurality of stores from a store terminal at the at least one store, and
the processor is further configured to store the received information indicating the store congestion state in the storage unit.

16. The system according to claim 9, wherein the storage unit stores menu information for each store in the plurality of stores.

17. A congestion notification method, comprising:
storing congestion information in a storage unit;
receiving, via a communication interface, a request for congestion information from a user terminal;
extracting the congestion information from the storage unit upon receiving the request, and
outputting the extracted congestion information to the user terminal via the communication interface, wherein
the congestion information output to the user terminal includes seat congestion information indicating a congestion state of seats shared by a plurality of stores.

18. The congestion notification method according to claim 17, wherein the plurality of stores are arranged as a food court.

19. The congestion notification method according to claim 17, wherein the congestion information output to the user terminal further includes store congestion information indicating a congestion state of at least one store in the plurality of stores.

20. The congestion notification method according to claim 17, further comprising:
extracting store congestion information indicating a congestion state of at least one store in the plurality of stores from the storage unit upon receiving a second request, via the communication interface, for congestion information from the user terminal, and
outputting the extracted store congestion information to the user terminal via the communication interface.
